(19) United States
(12) Patent Application Publication
(10) Pub. No.: US 2026/0370681 A1
(43) Pub. Date: Nov. 19, 2026

(54) USING ARTIFICIAL INTELLIGENCE TO IDENTIFY ANOMALOUS BEHAVIOR IN A DISTRIBUTED LEDGER

(71) Applicant: Micro Focus LLC, Wilmington, DE (US)

(72) Inventors: Douglas Max Grover, Rigby, ID (US); Michael F. Angelo, Houston, TX (US)

(21) Appl. No.: 19/672,233

(22) Filed: May 8, 2026

Related U.S. Application Data
(63) Continuation of application No. 18/766,648, filed on Jul. 9, 2024, now abandoned.

(51) Int. Cl. H04L 9/40

(52) U.S. Cl. CPC H04L 63/1458

(57) ABSTRACT

Activity of a blockchain in a distributed ledger is monitored by an AI algorithm to identify anomalous behavior in the distributed ledger. The anomalous behavior of the distributed ledger can comprise one or more of: an anomalous consensus vote of the distributed ledger; an anomalous activity of a mempool of the distributed ledger; a denial-of-service attack on the mempool of the distributed ledger; an anomalous change of information stored in the blockchain of the distributed ledger; and an anomalous voting time for a node in the distributed ledger. Detection of these types of anomalous behavior can be used to prevent attacks on the blockchain, thus contributing to the overall integrity and security of the blockchain.

### CROSS REFERENCE TO RELATED APPLICATION

The present application is a continuation of U.S. patent application Ser. No. 18/766,648, filed Jul. 9, 2024, entitled “USING ARTIFICIAL INTELLIGENCE TO IDENTIFY ANOMALOUS BEHAVIOR IN A DISTRIBUTED LEDGER”, which is incorporated herein by this reference in its entirety.

### BACKGROUND

While blockchains, when implemented with a distributed ledger, are supposed to be highly immutable, attacks to a blockchain can still occur. An attack of a blockchain can lead to the loss/corruption of information, invalid data being added to the blockchain, loss of access to the blockchain, malicious data being added to the blockchain, and/or the like. One of the problems with blockchains is that when invalid, corrupted, or malicious data is added to the blockchain, because of the high immutability of the blockchain, it is difficult to remove the invalid, corrupted, or malicious data.

### SUMMARY

These and other needs are addressed by the various embodiments and configurations of the present disclosure. The present disclosure can provide a number of advantages depending on the particular configuration. These and other advantages will be apparent from the disclosure contained herein.

Activity of a blockchain in a distributed ledger is monitored by an AI algorithm to identify anomalous behavior in the distributed ledger. The anomalous behavior of the distributed ledger can comprise one or more of: an anomalous consensus vote of the distributed ledger; an anomalous activity of a mempool of the distributed ledger; a denial-of-service attack on the mempool of the distributed ledger; an anomalous change of information stored in the blockchain of the distributed ledger; and an anomalous voting time for a node in the distributed ledger. Detection of these types of anomalous behavior can be used to prevent attacks on the blockchain, thus contributing to the overall integrity and security of the blockchain.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for using AI to identify anomalous behavior of a distributed ledger.

FIG. 2 is a flow diagram of a process for using AI to identify anomalous behavior of a distributed ledger.

FIG. 3 is a diagram of a user interface that is used to display anomalous behavior of a distributed ledger.

FIG. 4 is a diagram of a user interface that is used to display anomalous behavior of a distributed ledger.

FIG. 5 is a diagram of a blockchain with added anomaly blocks that describe anomalous behavior of a distributed ledger.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

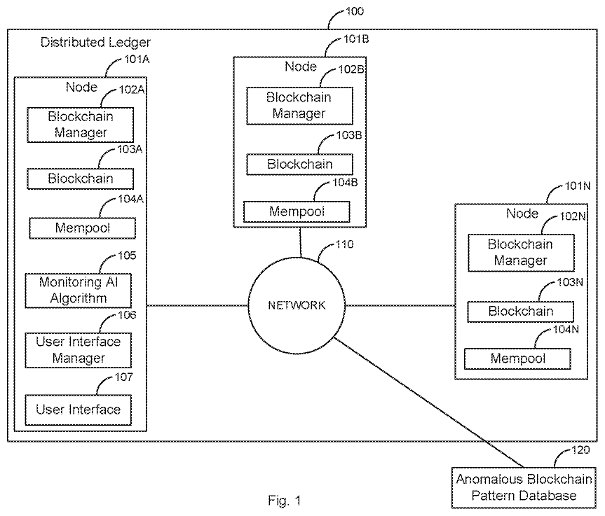

FIG. 1 is a block diagram of a first illustrative system for using AI to identify anomalous behavior of a distributed ledger 100. The first illustrative system comprises the distributed ledger 100, a network 110, and an anomalous blockchain pattern database 120. The distributed ledger 100 comprises nodes 101A-101N. The nodes 101A-101N and the anomalous blockchain pattern database 120 are connected together via the network 110.

The nodes 101A-101N are used to replicate the blockchain 103 in the distributed ledger 100. The nodes 101A-101N may be on different devices and/or on the same device. For example, the nodes 101A-101N may reside on different servers, in different containers, in different virtual machines, in nodes of a cloud service, and/or the like.

The nodes 101A-101N comprise blockchain managers 102A-102N, blockchains 103A-103N, and mempools 104A-104N. In addition, the node 101A further comprises a monitoring AI algorithm 105, a user interface manager 106, and a user interface 107. Although shown in the node 101A, the monitoring AI algorithm 105 may reside in any of the nodes 101A-101N, or on a node 101 that is not part of the distributed ledger 100. The user interface manager 106 and the user interface 107 may reside on a communication device that is external to the distributed ledger 100.

The blockchain managers 102A-102N are any hardware coupled with software/firmware that can manage the blockchains 103A-103N in the distributed ledger 100. The blockchain managers 102A-102N may include a consensus algorithm for the distributed ledger 100. The blockchain managers 102A-102N are used to add blocks to the blockchains 103A-103N. For example, a new transaction block may be added to the blockchains 103A-103N based on a node 101 submitting a transaction to the mempools 104A-104N of the distributed ledger 100.

The blockchains 103A-103N are a linked list of different blocks that comprise the blockchain 103. The blockchains 103A-103N are copies of the blockchain that is are used to provide increased immutability of blockchains 103A-103N in the distributed ledger 100.

The memory pool (mempool 104) is where transactions are queued to be added as blocks to the blockchains 103A-103N in each node 101A-101N of the distributed ledger 100. If the transaction blocks are not properly signed (i.e., a PKI validation failure), they are eventually removed from the mempools 104A-104N of the nodes 101A-101N of the distributed ledger 100. In other words, the mempool 104 is like a queue that is used to hold pending transactions that are to be added as blocks in the blockchains 103A-103N.

The monitoring AI algorithm 105 is used to monitor the distributed ledger 100/mempools 104B-104N to identify anomalous behavior. The monitoring AI algorithm 105 may be trained using a training set that has information associated with anomalous behavior in different distributed ledgers 100 (e.g., using a supervised AI model). Alternatively, or in addition, the monitoring AI algorithm 105 may use unsupervised learning or semi-supervised learning. The monitoring AI algorithm 105 may be use a machine learning model, a neural network, a GAN model, and/or the like.

The user interface manager 106 is used to take different kinds of anomalous information and provide the anomalous information to an administrator/security analyst (a user) via the user interface 107. The user interface manager 106 allows the administrator/security analyst to easily identify anomalous information about the distributed ledger 100, quickly make changes, and manage the anomalous behavior.

The user interface 107 is a graphical user interface that allows administrators/security analysts to view and manage anomalous behavior in the distributed ledger 100. The user interface 107 may be a Light Emitting Diode (LED) user interface, a plasma user interface, a cathode ray tube user interface, a touch screen user interface, and/or the like.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

The anomalous blockchain pattern database 120 is a database that stores learned anomalous blockchain patterns. The patterns may be learned by the monitoring AI algorithm 105, learned from an external monitoring AI algorithm 105 (e.g., one that is monitoring a different distributed ledger 100, and/or the like. The monitoring AI algorithm 105 can use the patterns from the anomalous blockchain pattern database 120 to identify patterns that are symptoms of an attack on the distributed ledger 100 to prevent the attack at an earlier point in the monitoring process.

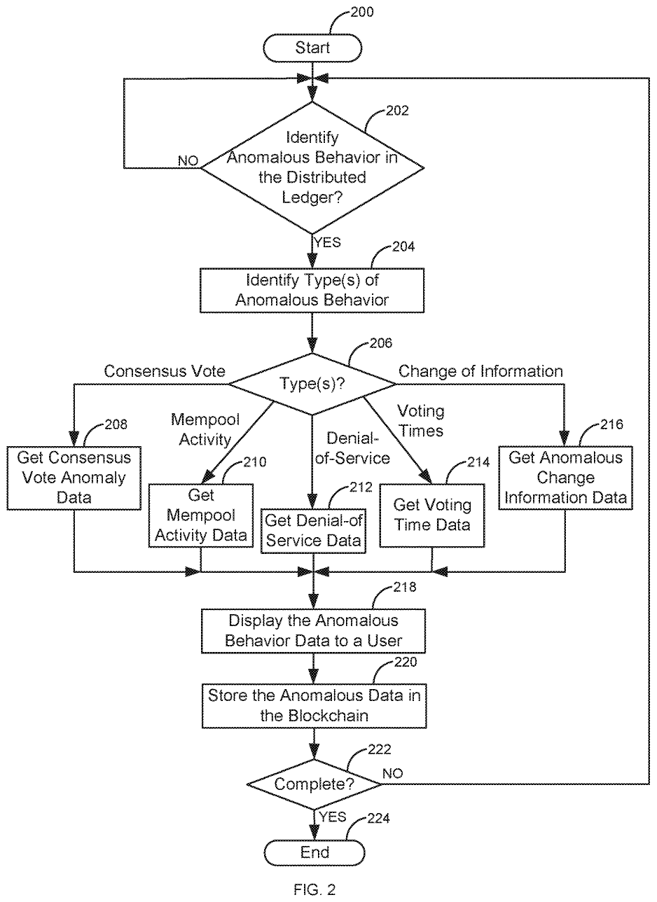

FIG. 2 is a flow diagram of a process for using AI to identify anomalous behavior of a distributed ledger 100. Illustratively, the distributed ledger 100, the nodes 101A-101N, the blockchain managers 102A-102N, the blockchains 103A-103N, the mempools 104A-104N, the monitoring AI algorithm 105, the user interface manager 106, the user interface 107, and the anomalous blockchain pattern database 120 are stored-program-controlled entities, such as a computer or microprocessor, which performs the method of FIGS. 2-5 and the processes described herein by executing program instructions stored in a computer readable storage medium, such as a memory (i.e., a computer memory, a hard disk, and/or the like). Although the methods described in FIGS. 2-5 are shown in a specific order, one of skill in the art would recognize that the steps in FIGS. 2-5 may be implemented in different orders and/or be implemented in a multi-threaded environment. Moreover, various steps may be omitted or added based on implementation.

In one embodiment, the monitoring AI algorithm 105 may be initially trained based on anomalous behavior of different blockchains 103/distributed ledgers 100. Alternatively, the monitoring AI algorithm 105 may use unsupervised learning to learn over time the normal behavior of the blockchains 103A-103N/distributed ledger 100. Based on the training, the monitoring AI algorithm 105 is used to identify anomalous behavior in blockchains 103A-103N and/or in nodes 101A-101N of the distributed ledger 100.

The process starts in step 200. The monitoring AI algorithm 105 monitors the distributed ledger 100 (which can include the nodes 101A-101N and the blockchains 103A-103N) to identify any anomalous behavior in step 202. The detection of anomalous behavior may be based on a defined threshold/variance. If there is no anomalous behavior identified in step 202, the process of step 202 repeats.

Otherwise, if there is identified anomalous behavior in step 202, the monitoring AI algorithm 105 identifies the type(s) of anomalous behavior in step 204. The types of anomalous behavior may be unrelated or related. For example, a consensus attack where some of the nodes 101A-101N are voting in an anomalous way may also have anomalous voting times. Alternatively, the anomalous voting times may be the only anomalous type of behavior identified by the monitoring AI algorithm 105.

Based on the identified anomalous behavior type(s) of step 204, the different types of anomalous behavior are managed differently. If there are multiple types of anomalous behavior in step 206, the different types may be managed in parallel and/or series.

If an anomalous consensus vote is identified in step 206, the monitoring AI algorithm 105 gets the anomalous consensus vote data in step 208. An anonymous consensus vote is where one or more nodes 101 are voting differently versus how the one or more nodes 101 previously voted. For example, if all of a sudden, the node 101A was consistently voting to not validate an addition of a new block to the blockchain 103, this may indicate that the node 101A may be failing or has been compromised. An anomalous consensus vote may be where all of a sudden, the consensus vote to approve a transaction goes from always being 100% to 52%.

The data captured for an anomalous consensus vote may include which nodes are now voting in the anomalous way, the transaction being voted on, a time when the anomalous vote takes place, the node 101 that proposed adding the transaction/block to the blockchains 103A-103N, and/or the like. The information may also include information about the type of consensus algorithm being used. Based on the type of consensus algorithm, the collected anomalous information may be different. Below are some examples of the types of anomalous behaviors that can be identified based on the particular consensus voting mechanism of a particular blockchain 103.
Proof of Work—This is where nodes 101 of distributed ledger 100 solve complex mathematical puzzles to recommend adding a block to the blockchain 103. For a proof of work consensus voting process, the monitoring AI algorithm 105 can monitor for different types of attacks, such as, a new group of node(s) 101 that are now winning the proof of work much more than in the past (e.g., they are now using quantum computing), a change in the number of nodes 101 approving a transaction, an anomalous addition of a group of nodes 101 over a time period, an anomalous dropping of a number of nodes 101 over a time period, and/or the like.
Proof of Stake—is based on who owns the most tokens (e.g., Bitcoins) that are in the blockchain 103. Thus, if a node 101 or a group of nodes 101 now have more tokens, it is more likely to for the group of nodes 101 to add a new block to the blockchain 103 because they now have a majority of tokens. An anonymous behavior may be where a new node 101, an existing node 101, or a group of nodes 101 all of a sudden or over a time period now owns more tokens. For example, a small group of malicious nodes 101 all of a sudden is in control of more than 50% of the tokens and can now control the voting process, this can be flagged as a potential attack on the blockchain 103.
Designated Proof of Stake—is where nodes 101 can be grouped based on their stake (e.g., a number of tokens). The monitoring AI algorithm 105 can look for anomalous behavior/voting patterns/changes in stakes of the nodes 101 in the distributed ledger 100 similar to the proof of stake consensus algorithm.
Proof of Capacity—this is where the puzzle requires a large amount of storage space. The monitoring AI algorithm 105 can look for anomalous votes/winers of the puzzle solving. For example, if a new node 101 or group of nodes 101 have a much larger number of capacity and start winning the addition of blocks may be flagged. A decrease in nodes 101 or an increase in nodes 101 can also be flagged.
Proof of Elapsed time—this consensus algorithm is based on how long someone has waited, the longest waiting wins. The monitoring AI algorithm 105 can look and see anomalous patterns where nodes 101 that have been waiting longer are now not winning the contest to add blocks. It can identify the nodes 101 that are now winning but should be waiting.
Proof of Identity—this consensus algorithm uses Private Key Infrastructure (PKI) to establish that a node 101 can add a block to the blockchain 103. The monitoring AI algorithm 105 can look for patterns on failures of nodes 101, new node(s) 101 that are being added (e.g., to take over a distributed ledger 100). The monitoring AI algorithm 105 can look for new groups of nodes 101 that are taking over the voting process. For example, if the PKI private key has been compromised, new nodes 101 that have the compromised key can now take over the voting process and control the blockchain 103/distributed ledger 100.
Proof of Authority—this consensus algorithm is a higher-level version of the proof of identity consensus algorithm. The proof of authority consensus algorithm requires personal identification. The monitoring AI algorithm 105 can look for similar issues as the proof of identity. In addition, the monitoring AI algorithm 105 can look for anomalous patterns in the proof of identity. For example, if the proof of identity is different for a user than was previously used, this can be flagged as an anomaly.
Proof of Activity—this consensus algorithm uses smaller puzzles along with address and header information. The monitoring AI algorithm 105 can look for anomalous voting patterns in what nodes 101 are winning/losing based on the address/header information. The monitoring AI algorithm 105 can monitor voting patterns based on specific addresses/header information.
Proof of Burn—This works where coins (e.g., Bitcoins) are sent to an address that is irretrievable. This gives the validators a privilege the mine the system based on a random selection process. The monitoring AI algorithm 105 can look anomalous burning of coins or changes in patterns of how coins are burned.
Forks in a given time (changes in the consensus algorithm). If there is a change in the consensus algorithm, this can be flagged, and an administrator/security analyst may be notified. The administrator/security analyst can block or approve the change in consensus algorithm by authenticating at a specific authentication level. For example, the administrator/security analyst may be required to authenticate at level two authentication that not only requires a username/password, but also requires an iris scan. The approval may require multiple parties to approve the change in the consensus algorithm. For example, if there are two parties that use a supply chain distributed ledger 100, both parties may have to approve the change of the consensus algorithm in order to fork the blockchain 103 and switch the consensus algorithm. The approval of the change in consensus algorithm may be tracked in the blockchain 103/distributed ledger 100 in a change in consensus algorithm block being added to the blockchain 103 along with who approved the change in consensus algorithm. The block may have a signed certificate of the person who approved the change in the consensus algorithm.

Another option would be for the monitoring AI algorithm 105 to look for changes in constituency (applies to all consensus algorithms). An example is where the number of nodes 101 stay the same but take over a voting node(s) 101 and/or replace existing node(s) 101. The node(s) 101 in the distributed ledger 100 may be replaced by malicious nodes 101M (identified as nodes 101M), by additions of a larger number of malicious nodes 101M that are voting differently or vote differently at a point in time, and/or the like.

For example, assume that the distributed ledger 100 comprises twenty nodes 101A-101N that currently vote. Over time, twenty-one new malicious nodes 101M are added to the distributed ledger 100. The new malicious nodes 101M continue to vote like the original nodes. All of a sudden, when the new malicious nodes 101M have a majority and a new block is requested to be added to the blockchains 103A-103N, the twenty-one malicious nodes 101M vote to add the malicious block to the blockchains 103A-103N while the original twenty nodes 101A-101N vote to not add the block to the blockchain 103. Thus, the malicious nodes 101M have compromised the blockchain 103. Similarly, existing nodes 101 may be compromised and vote normally until the compromised nodes 101 have a majority. This type of anomalous behavior can be flagged. The addition of the block can be identified as likely being a malicious/fraudulent block in the blockchain 103.

If the anomalous behavior is associated with the memory pool (mempool 104) in step 206, the mempool 104 activity data is gathered in step 210. The monitoring AI algorithm 105 can identify specific node(s) 101 that are not validating the block additions (could be a rogue node 101 or failing node 101). This can include tracking how each node 101 responds to the addition of each block/type of block in the blockchain 103. For example, an anomalous pattern may be where a specific node(s) 101 does not validate a specific type of transaction block while always validating all other types of transaction blocks. The monitoring AI algorithm 105 can monitor the mempool 104 of the node(s) 101 and then look at its mempool 104/voting patterns in comparison to how the other nodes 101 are voting.

The mempool 104 can also prioritize approval of transactions as part of the normal voting process. The anomaly identification process can include looking for anomalies in how new transactions are prioritized over other transactions (e.g., different types of transactions) in the local mempool 104. For example, if a node 101 is always submitting prioritized transactions where in the past, the same node 101 rarely submitted prioritized transaction requests. Another option is where regular transaction requests are being prioritized when they should not be prioritized or where prioritized transaction requests that are supposed to be prioritized are now not being prioritized. The monitoring AI algorithm 105 can identify the specific node(s) 101 that are involved in the anomalous prioritization.

In addition, a size of the mempool 104 may be anomalous based on time. For example, the mempool 104 may have an average size at a particular time (e.g., time of day, time of week, time of year, time of transaction, time of transaction type, time of prioritization of a specific type of transaction, etc.). If there are dramatic changes/ramping up of changes in the size of the mempool 104/type of transactions in the mempool 104 at a specific time (e.g., it is significantly larger or significantly smaller), this can be flagged as anomalous behavior. For example, if the size of the mempool 104 is normally a specific size during out-of-hours and if the size of the mempool 104 is dramatically different during the same out-of-hours time period, this can be flagged. Likewise, if the size of the mempool 104 dramatically changes during working hours, this can be flagged. Another example would be where a number of prioritized transactions received during a time period is anomalous in comparison to the normal number of prioritized transactions at the same time period (e.g., during working hours). Anomalous behavior may be where there is a number of a specific type of transactions that are anomalous in comparison the normal number of the specific types of transactions for the same time period.

If the anomalous behavior in step 206 is a denial-of-service attack, the denial-of-service data is gathered in step 212. A denial-of-service attack occurs when one or more malicious nodes 101M send a large number of bogus transaction requests. Thus, the distributed ledger 100 may not be able to service legitimate transactions because they time out in the mempool 104 or are too many for the size of the mempool; this is because the nodes 101A-101N in the distributed ledger 100 are processing so many illegitimate transaction requests.

The monitoring AI algorithm 105 can monitor for this kind of attack and block the nodes 101 that are making illegitimate requests. For example, the monitoring AI algorithm 105 may send out a request for the other nodes 101 in the distributed ledger 100 to block the malicious node 101M. The blocking may be based on a number of illegitimate requests in a time period. For example, the nodes 101A-101N in the distributed ledger 100 may have a consensus protocol to vote nodes 101 out of the distributed ledger 100 based on the number of illegitimate requests in the time period. Once a node 101 is voted out of the distributed ledger 100, the remaining nodes 101 block any incoming requests from the malicious node(s) 101M.

If the identified type of anomalous behavior in step 206 is based on voting times of the nodes 101 in the distributed ledger 100, the monitoring AI algorithm 105 gets the voting time data in step 214. A voting time anomaly is where is the consensus voting process happens much faster or slower than normal. This also may be based on a time period. For example, if the consensus algorithm has been circumvented in one or more nodes 101 in the distributed ledger 100 and the consensus vote takes less time or takes much longer than previously, this can be flagged along with the nodes 101 where it takes a longer/shorter time.

If the anomalous behavior is a change of information anomaly in step 206, the monitoring AI algorithm 105 gets the anomalous change data in step 216. The anomalous change data may be identified based on information stored in the blocks of the blockchain 103. For example, if the fields of a block are all of a sudden different (e.g., added fields, removed fields), if a size of files stored in a block for a specific type of transaction are different (e.g., much larger or smaller), if a number of links is different in a specific type of block in the blockchain 103, if a structure of the blockchain 103 is different (e.g., a new branch is made where there were no previous branches in the blockchain 103), if a size of the fields in blocks are different, if information pointed to by links in specific types of blocks is different (e.g., in a different format/size) or non-existent, if links are suddenly pointing to a different location (e.g., the link may now point to a malicious website or file of a blacklisted website), and/or the like can be flagged.

The monitoring AI algorithm 105 can look at block additions over time. The monitoring AI algorithm 105 can look for patterns of which nodes 101 request to add blocks (e.g., is a node 101 that was regularly requesting to add blocks now not making any requests, is a node 101 that never made requests now making requests, etc.). The monitoring AI algorithm 105 may also look for new block types that are added that have never before been added. The monitoring AI algorithm 105 can look at block branching patterns to identify anomalous patterns. The monitoring AI algorithm 105 can look at the patterns for each branch and how a new branch is created that is not similar. For example, the types of blocks/order of blocks are now different than they were previously. The monitoring AI algorithm 105 can look at user information in the blocks, timing of requests to add blocks to the blockchain 103/distributed ledger 100 (e.g., it now takes a lot longer or now takes much less time between block requests), time it takes to add a new block (are blocks now being added much quicker than before), and/or the like.

Once all the data is gathered in steps 208, 210, 212, 214, and/or 216, the anomalous behavior data may be displayed to an administrator/security analyst in the user interface 107 in step 218. The user interface manager 106 may generate different images in the user interface 107 to allow the administrator/security analyst to better manage and identify anomalous behavior in the distributed ledger 100.

The monitoring AI algorithm 105 may then store the anomalous data in the blockchains 103A-103N in step 220. For example, if a denial-of-service anomaly has been identified, a denial-of-service anomaly block may be stored in the blockchain 103. The denial-of-service anomaly block may indicate a time that the denial-of-service attack occurred, which node(s) 101 participated in the denial-of-service attack, etc.

The process determines, in step 222, if the process is complete. If the process is not complete in step 222, the process goes back to step 202. Otherwise, if the process is complete in step 222, the process ends in step 224.

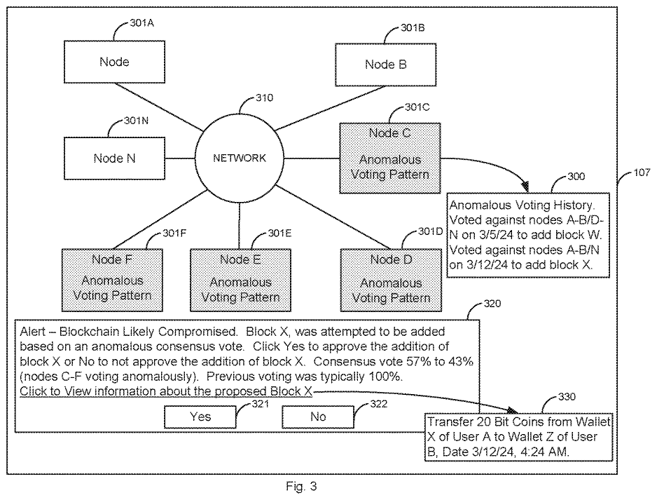

FIG. 3 is a diagram of a user interface 107 that is used to display anomalous behavior of a distributed ledger 100. The user interface 107 comprises node images 301A-301N, a network image 310, an anomalous voting window 300, an alert window 320, and a transaction window 330.

The nodes images 301A-301N are visual representations of the nodes 101A-101N in the distributed ledger 100. The node images 301A-301N may vary in appearance and/or color based on how the anomalous data is displayed in the user interface 107.

The network image 310 is visual representation of the network 110. The network image 310 is shown as being connected to the node images 301A-301N to visually represent the distributed ledger 100.

The anomalous voting window 300 is used to display an anomalous voting history of a specific node image 301 (node image 301C in this example). The anomalous voting window 300 is displayed when the user clicks on the node image 301C.

The alert window 320 is used to display alerts to the administrator/security analyst. The alert window 320 contains information about a specific alert. For example, in FIG. 3, the alert window 320 is for a consensus vote attack.

The transaction window 330 is used to display specific transactions associated with a particular anomalous behavior. In FIG. 3, the transaction window 330 is displayed in response to the administrator/security analyst clicking on the link in the alert window 320.

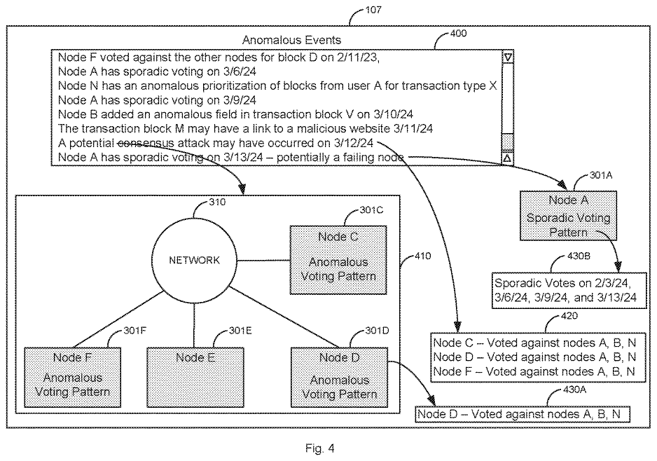

As anomalies are identified in step 204 and displayed to the administrator/security analyst in step 218, the structure of the blockchains 103A-103N/distributed ledger 100 may be shown to the administrator/security analyst in the user interface 107. FIG. 3 shows an example of a user interface 107 that may be provided to the administrator/security analyst based on a specific type of anomalous event (e. g., where the administrator/security analyst selected the event from a list as described in FIG. 4).

In FIG. 3, the node images 301A-301N and the network image 310 are displayed in the user interface 107 to visually represent the distributed ledger 100. FIG. 3 is an example of where the distributed ledger 100 has been compromised by a consensus voting attack. In FIG. 3, the nodes 101A, 101B, and 101N have not been compromised and thus the node images 301A, 301B, and 301N not highlighted. The nodes 101C-101F have been compromised and thus the node images 301C-301F are highlighted. The node images 301C-301F are highlighted to show that the nodes 101C-101F have been compromised and how they have been compromised. For example, the node images 301C-301F may have their background highlighted in red and the anomalous voting pattern text flashing in blue.

The alert window 320 identifies the type(s) of anomalous behavior. In this example, the type of alert is that the distributed ledger 100 has been compromised based on an anomalous consensus vote of the nodes 101C-101F that was 57% compared to 43% of the non-compromised nodes 101A, 101B, and 101N. Previously the consensus voting pattern was typically a 100% consensus vote.

The administrator/security analyst may be given the option to approve the addition of the block X, which appears to be a fraudulent transaction by clicking on the Yes button 321 or not approving the transaction by clicking on the No button 322. The administrator/security analyst can click on the link in the alert window 320 to view the transaction associated with addition of the block X in the transaction window 330. In this example, the transaction is to transfer 20 bitcoins from the wallet X of user A to the wallet Z of user B on Mar. 12, 2024 at 4:24 AM. If the administrator/security analyst approves/does not approve the transaction, an approval block/not approval block can be added to the blockchain 103 along with all the information associated with the anomalous behavior.

The monitoring process can be extended further to compare similar types of blockchains 103 and look for differences between the similar blockchains 103 to identify anomalous patterns. For example, a company may have an application that creates a blockchain 103/distributed ledger 100 to track supply chain transactions for various shipping companies. The data (e.g., anonymized data) may be compared in each of the blockchains 103 to create a baseline of how the supply chain blockchain application's blockchains 103 normally work. Variances from the norm can be identified and flagged.

Over time, the learned anomalous patterns can be identified/classified and stored in the anomalous blockchain pattern database 120 that can be used to identify a similar attack on other blockchains 103/distributed ledgers 100. The monitoring AI algorithm 105 can also download the patterns from the anomalous blockchain pattern database 120 and then look in real-time for different types of attacks to flag the attack in real-time before the attack can be completed. Attack pattern(s) searching may look for in sequence or out of sequence patterns. For example, an out of sequence pattern may have all the steps, but they are in a slightly different order of occurrence.

In addition, when anomalous behavior is identified, specific actions may be taken. For example, specific block additions can be blocked, addition of new blocks can be suspended, nodes 101 in the distributed ledger 100 can be blacklisted, the blacklisted nodes 101 may be sent to the anomalous blockchain pattern database 120, the distributed ledger 100 may be shutdown, the distributed ledger 100 may be quarantined, an administrator(s) may be required to approve the addition of the block, a node 101 may be identified as likely failing, a node 101 may be scanned to verify that the code of the node has not been modified, a node 101 may be reset, a node 101 may be reimaged, a container/virtual machine of a node 101 may be scanned for malware, a hypervisor of a node 101 may be scanned for malware, a hash check may be done on a node 101/parts of a node 101, and/or the like.

The actions may be administered and may be different based on the type of anomalous behavior. For example, if a single node 101 looks like it may be failing, the administrator/security analyst may be notified. On the other hand, if the anomalous pattern looks like a consensus attack of the distributed ledger 100, the nodes 101 that appear to be part of the consensus attack may be blocked from the consensus voting, the list of nodes 101/addresses of the nodes 101 may be sent to the anomalous blockchain pattern database 120, and the administrator/security analyst may be notified and given different options to deal with the consensus attack.

In FIG. 3, the administrator/security analyst can click on a specific node image 301 to view an anomalous history of the specific node 101. For example, in FIG. 3 the administrator/security analyst has clicked on the node image 301C to view the anomalous voting history of the node 101C in the anomalous voting window 300. The node 101C has had two anomalous votes: 1) on Mar. 5, 2024 where the node 101C voted against nodes 101A-101B/101D-101N when the nodes 101A-101B/101D-101N approved the addition of block W, and 2) on Apr. 12, 2024 where the node 101C voted with nodes 101D-101F and against nodes 101A, 101B, and 101N to approve the addition of block X in the blockchain 103. The node history in the anomalous voting window 300 may be scrollable, based on time period (e.g., over the last month), based on a number of anomalies, and/or the like.

The alert window 320 can be displayed based on any type of anomalous event. For example, if the node 101A was having an anomalous voting pattern (e.g., the node 101 is failing because it sometimes does not respond and vote on a transaction), the node image 301A may be highlighted in the user interface 107 along with information of why the node 101A may be failing, such as its failure to respond. The administrator/security analyst may be able to click on the node image 301A to view additional information about the anomalous behavior of the node 101A. For example, if the anomalous behavior is where the node 101A is now prioritizing specific transactions (e.g., transactions for a specific user) where it previously was not, this information may be displayed to the administrator/security analyst in more detail by clicking on the node image 301A.

FIG. 4 is a diagram of a user interface 107 that is used to display anomalous behavior of a distributed ledger 100. In FIG. 4, the user interface 107 comprises the node image 301A, an anomalous events window 400, an anomalous node window 410, an anomalous history window 420, and individual node anomalous history windows 430A and 430B.

The anomalous events window 400 is used to display a list of ongoing anomalous events (the anomalous distributed ledger events) for the nodes 101A-101N. The anomalous events window 400 allows the administrator/security analyst to scroll through and learn more about specific anomalous events in the distributed ledger 100.

The anomalous node window 410 is used to display all the nodes 101 that are involved on a specific type of event clicked on in the anomalous events window 400 by the administrator/security analyst. For example, in FIG. 4 the administrator/security analyst has right clicked in the event “A potential consensus attack may have occurred on Mar. 12, 2024,” which resulted in the display of the anomalous node window 410.

The anomalous history window 420 displays a history of the nodes 101 associated with the event “A potential consensus attack may have occurred on Mar. 12, 2024.” For example, the anomalous history window 420 may be displayed when the administrator/security analyst left clicks the particular anomalous event.

The individual node anomalous history windows 430A and 430B are displayed when the administrator/security analyst clicks on a particular node image 301. For example, the individual node anomalous history window 430A is displayed when the administrator/security analyst clicks on the node image 301D. Likewise, the individual node anomalous history window 430B is displayed when the administrator/security analyst clicks on the node image 301A.

The administrator/security analyst can the click on a specific event in the anomalous event window 400 and then the nodes 101 that are associated with the particular anomalous event can be displayed. For example, the administrator/security analyst clicked on the event “A potential consensus attack may have occurred on Mar. 12, 2024.” This results in only displaying the nodes images 301C-301F that are part of the potential consensus attack of nodes 101C-101F that occurred on Mar. 12, 2024.

Likewise, if the administrator/security analyst clicks on the event “Node A has a sporadic voting on Mar. 13, 2024”, the node image 301A is then displayed to the administrator/security analyst. The administrator/security analyst can then click on the node image 301A to view the sporadic voting events associated with the node 101A. For example, when clicking on the node image 301A, the sporadic voting events on Mar. 6, 2024, Mar. 9, 2024, and Mar. 13, 2024 can be displayed.

Instead of displaying the blockchain structure as in FIG. 3, the individual node images 301 may be listed as an alternative as shown in FIG. 4. The administrator/security analyst can then click on a specific node image 301 in the list to display more detailed information about the node 101 for the particular security event.

Another option would be to provide the necessary information instead of having the administrator/security analyst click on various levels of data. In this example, the user interface manager 106 includes an AI algorithm. The administrator/security analyst could be initially displayed the list of anomalous events and then pick an anomalous event(s) along with specific information the administrator/security analyst wants displayed in the user interface 107. For example, the administrator/security analyst could say “display all the nodes associated with the potential consensus attack that occurred on Mar. 12, 2024 along with the voting history of the nodes associated with the potential consensus attack from Jan. 1, 2024 until the potential consensus attack was identified. Also include the information associated with the block that was requested to be added.” Based on this input, the user interface manager 106 would then gather the necessary information and present the administrator/security analyst with the requested information.

For large distributed ledgers 100 (or even for distributed ledgers 100 like described herein), the user interface 107 may only show a portion of the node images 301 in the distributed ledger 100 or all of the node images 301A-301N in the distributed ledger 100.

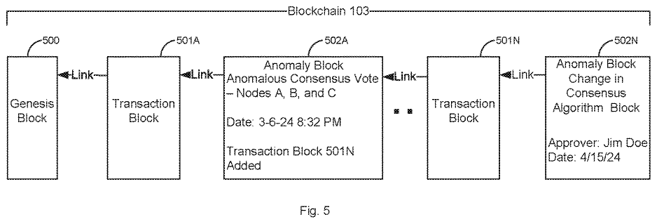

FIG. 5 is a diagram of a blockchain 103 with added anomaly blocks 502A-502N that describe anomalous behavior of a distributed ledger 100. The blockchain 103 of FIG. 5 comprises a genesis block 500, transaction blocks 501A-501N, and anomaly blocks 502A-502N.

The genesis block 500 is a first block that is created to start the blockchain 103. The genesis block 500 may contain information associated with the blockchain 103.

The transaction blocks 501A-501N are blocks that are added to the blockchain 103 based on a transaction. A transaction is typically based on an event that occurs. For example, the event may be payment has been received for purchasing a product.

The anomaly blocks 502A-502N are blocks that are added to the blockchain 103 based on an anomalous event. For example, in FIG. 5, the anomaly block 502A was added based on a consensus vote anomaly of nodes 101A, 101B, and 101C that occurred on Mar. 6, 2024 at 8:32 PM. In addition, the anomaly block 502A also identifies the transaction block 501N that was added based on the anomalous consensus vote. The anomaly block 502N is added was when there was an anomalous change in the consensus algorithm.

Once anomalous patterns are identified, a new anomaly block 502 may be added to the blockchain 103. For example, if a new denial-of-service anomaly is identified, a new anomaly block 502 may be added to the blockchain 103 along with specific details associated the denial-of-service attack. The anomaly block 502 may be added based on an administrator/security analyst approval. Likewise, if an information anomaly is identified, the monitoring AI algorithm 105 may request to add an anomalous information block 502 to the blockchain 103. This may also require the administrator/security analyst to approve the addition of the anomaly block 502 to the blockchain 103.

Examples of the processors as described herein may include, but are not limited to, at least one of Qualcomm® Snapdragon® 800 and 801, Qualcomm® Snapdragon®610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users'premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. As system, comprising:
a microprocessor; and
a computer readable medium, coupled with the microprocessor and comprising microprocessor readable and executable instructions that, when executed by the microprocessor, cause the microprocessor to:
monitor, using a monitoring artificial intelligence (AI) algorithm, activity of a blockchain in a distributed ledger to identify an anomalous behavior in the distributed ledger;
wherein the anomalous behavior of the distributed ledger comprises one or more of:
a denial-of-service attack on the mempool of the distributed ledger; and
an anomalous change of information stored in the blockchain of the distributed ledger,
wherein the anomalous behavior of the distributed ledger comprises the denial-of-service attack on the mempool of the distributed ledger;
in response to identifying the denial-of-service attack on the mempool of the distributed ledger, initiate a consensus vote to remove a node from the distributed ledger that is responsible for the denial-of-service attack;
determine that the consensus vote has approved the removal of the node responsible for the denial-of-service attack; and
in response to determining that the consensus vote has approved the removal of the node responsible for the denial-of-service attack, remove, from the distributed ledger, the node responsible for the denial-of-service attack.

2. The system of claim 1, wherein the anomalous behavior of the distributed ledger further comprises an anomalous consensus vote of the distributed ledger.

3. The system of claim 2, wherein the anomalous consensus vote of the distributed ledger is based on one of the following: a proof of stake consensus algorithm, a designated proof of stake consensus algorithm, a proof of capacity consensus algorithm, a proof of elapsed time consensus algorithm, a proof of identity consensus algorithm, a proof of authority consensus algorithm, a proof of activity consensus algorithm, a proof of burn consensus algorithm, and a change in a consensus algorithm.

4. The system of claim 3, wherein the anomalous behavior is different based on a particular consensus algorithm of the distributed ledger.

5. The system of claim 1, wherein the anomalous behavior of the distributed ledger further comprises an anomalous activity of the mempool of the distributed ledger.

6. The system of claim 5, wherein the anomalous activity of the mempool of the distributed ledger is an anomalous activity of at least one of: how transactions in the mempool of the distributed ledger are prioritized, a size of the mempool, a type of transaction in the mempool, and a change in the size of the mempool in a time period.

7. The system of claim 1, wherein the anomalous behavior of the distributed ledger comprises the anomalous change of information stored in the blockchain of the distributed ledger.

8. The system of claim 7, wherein the anomalous change of information stored in the blockchain of the distributed ledger is one of: a change of a field in the blockchain of the distributed ledger, a size of a file stored in the blockchain of the distributed ledger, a number of links in a block in the blockchain of the distributed ledger, and a change in information pointed to by a link in the blockchain of the distributed ledger.

9. The system of claim 1, wherein the anomalous behavior of the distributed ledger further comprises an anomalous voting time for a node in the distributed ledger.

10. The system of clam 1, wherein the anomalous behavior of the distributed ledger is displayed in a user interface, wherein a user can click on the anomalous behavior of the distributed ledger to view which nodes in the distributed ledger are part of the anomalous behavior of the distributed ledger.

11. The system of claim 10, wherein the user can click on an individual node of the nodes in the distributed ledger that are part of the anomalous behavior of the distributed ledger to view a history of the individual node.

12. The system of claim 1, wherein the anomalous behavior in the distributed ledger is identified based on a pattern of the anomalous behavior of the distributed ledger that is stored in an anomalous blockchain pattern database.

13. The system of claim 1, wherein information about the anomalous behavior of the distributed ledger is stored in an anomaly block the blockchain.

14. A method, comprising:
monitoring, by a microprocessor executing a monitoring artificial intelligence (AI) algorithm, activity of a blockchain in a distributed ledger to identify an anomalous behavior in the distributed ledger;
wherein the anomalous behavior of the distributed ledger comprises one or more of:
a denial-of-service attack on the mempool of the distributed ledger; and
an anomalous change of information stored in the blockchain of the distributed ledger,
wherein the anomalous behavior of the distributed ledger comprises the denial-of-service attack on the mempool of the distributed ledger;
in response to identifying the denial-of-service attack on the mempool of the distributed ledger, initiating, by the microprocessor, a consensus vote to remove a node from the distributed ledger that is responsible for the denial-of-service attack;
determining, by the microprocessor, that the consensus vote has approved the removal of the node responsible for the denial-of-service attack; and
in response to determining that the consensus vote has approved the removal of the node responsible for the denial-of-service attack, removing by the microprocessor, from the distributed ledger, the node responsible for the denial-of-service attack.

15. The method of claim 14, wherein the anomalous behavior of the distributed ledger further comprises an anomalous consensus vote of the distributed ledger.

16. The method of claim 14, wherein the anomalous behavior of the distributed ledger further comprises an anomalous voting time for nodes in the distributed ledger.

17. A non-transient computer readable medium having stored thereon instructions that cause a microprocessor to execute a method, the method comprising instructions to:
monitor, by a microprocessor using a monitoring artificial intelligence (AI) algorithm, activity of a blockchain in a distributed ledger to identify an anomalous behavior in the distributed ledger;
wherein the anomalous behavior of the distributed ledger comprises one or more of:
a denial-of-service attack on the mempool of the distributed ledger; and
an anomalous change of information stored in the blockchain of the distributed ledger,
wherein the anomalous behavior of the distributed ledger comprises the denial-of-service attack on the mempool of the distributed ledger;
in response to identifying the denial-of-service attack on the mempool of the distributed ledger, initiating, by the microprocessor, a consensus vote to remove a node from the distributed ledger that is responsible for the denial-of-service attack;
determining, by the microprocessor, that the consensus vote has approved the removal of the node responsible for the denial-of-service attack; and
in response to determining that the consensus vote has approved the removal of the node responsible for the denial-of-service attack, removing by the microprocessor, from the distributed ledger, the node responsible for the denial-of-service attack.

18. The non-transient computer readable medium of claim 17, wherein the anomalous behavior of the distributed ledger comprises the anomalous change of information stored in the blockchain of the distributed ledger.

19. The non-transient computer readable medium of claim 18, wherein the anomalous change of information stored in the blockchain of the distributed ledger is one of: a change of a field in the blockchain of the distributed ledger, a size of a file stored in the blockchain of the distributed ledger, a number of links in a block in the blockchain of the distributed ledger, and a change in information pointed to by a link in the blockchain of the distributed ledger.

20. The non-transient computer readable medium of claim 17, wherein the anomalous behavior of the distributed ledger further comprises an anomalous voting time for a node in the distributed ledger.
